(19) United States
(12) Patent Application Publication
(10) Pub. No.: US 2022/0375323 A1
(43) Pub. Date: Nov. 24, 2022

(54) MOBILE PHONE REMINDER DEVICE

(71) Applicants: Avi Nelson, N. Reading, MA (US); Angelo Tortola, Lexington, MA (US); Charles S. Sebor, Reading, MA (US)

(72) Inventors: Avi Nelson, N. Reading, MA (US); Angelo Tortola, Lexington, MA (US); Charles S. Sebor, Reading, MA (US)

(21) Appl. No.: 17/749,426

(22) Filed: May 20, 2022

Related U.S. Application Data
(63) Continuation-in-part of application No. 17/363,905, filed on Jun. 30, 2021, now abandoned.
(60) Provisional application No. 63/192,341, filed on May 24, 2021.

(51) Int. Cl. G08B 21/24; H04M 1/725

(52) U.S. Cl. CPC G08B 21/24; H04M 1/725

(57) ABSTRACT

A device placed or installed in a user's vehicle or other venue and operative to sense the opening and/or closing of a venue door and to be in wireless communication with a user's cell phone. When a user is entering, for example, a vehicle, the device senses door opening and/or closing and is triggered to search for the user's phone. Upon detection of that phone, the device provides an alert to the user that the phone is present. If the phone is not present, the device senses such absence and provides an alert that the phone is not present. Similar alerts are provided by the device when the user exits the vehicle. The device is also useable in other venues having a door. The system can also be used in devices other than cell phones that have similar communications capability to communicate with the system described herein. In a preferred embodiment, the door sensor is an accelerometer or proximity sensor operative to monitor one or more elements of a door lock mechanism and provide a unique signal profile or signature of the monitored lock mechanism. The unique profile is stored in memory and used to compare with subsequently obtained signal profiles to identify the particular door lock of a user's vehicle. Upon a positive profile comparison, a trigger signal is produced to start a processing operation to determine whether or not the user's cell phone is present in the vehicle or other monitored site.

### BACKGROUND OF THE INVENTION

Cell phones have become a ubiquitous presence and are carried by most people as they go about their daily activities. It is not uncommon for people to forget or misplace their phones, and remedies have been developed to assist persons in locating a missing cell phone. There are apps such as: “Find My Phone” which allow people to locate a missing phone. There are also wireless tracking devices that include a fob attachable to the phone and which allow Bluetooth or other wireless communication with a base station to identify the location of a missing phone. But such wireless trackers require the use of a fob or other small device which is attachable to the phone to be protected.

A common problem arises when a person enters or exits his or her car or other vehicle and discovers after entering the car that the phone is not present, or after exiting the car that the phone has been left in the car. It is not uncommon for a person to recall that the phone is missing and has been forgotten only after the car is being driven. It is also not uncommon for a person to become aware that the phone has been left in the car only after entering a house, restaurant or other venue.

It would be useful to provide a means for reminding a user when entering his or her vehicle to have the phone present before driving away. It would also be useful to remind a user not to forget the user's cell phone when leaving the user's vehicle. In both cases, it would be good to accomplish this without a fob or additional item for the user to carry.

### SUMMARY OF THE INVENTION

This invention requires no tiles or anything else for the user to carry. A preferred embodiment employs an accelerometer or proximity sensor which is capable of sensing the movement of one or more elements of a latch or lock mechanism of a door being monitored and/or the acceleration of a door opening and/or closing. This can be a door to a building or a vehicle, or anything else that produces acceleration upon opening/closing. In the context of a motor vehicle, the latch or lock mechanism of a vehicle door and/or the door opening/closing motion are monitored in accordance with the invention to determine if a cell phone or other personal electronic device is present when the user enters or exits the vehicle. Upon the vehicle door opening, a command signal is provided to start the process of determining whether or not a previously married cell phone is near enough to the phone reminder to be detected. If so detected, the invention issues a positive audio and/or visual indication. If not detected, the invention issues a negative audio and/or visual indication. Upon user exit from the vehicle, a positive signal serves to remind the user to take their phone with them. Upon user entry into the vehicle, a negative signal serves to remind the user to bring his or her phone with them.

Thus, upon user entry into the vehicle, a negative signal services to remind the user to bring their phone with them. A positive signal indicates the phone is present. Upon user exit from the vehicle, a positive signal services to remind the user to take their phone with them. A negative signal indicates the phone is absent (which the user may have already know from a prior signal upon entry).

Similar considerations apply to door or entry elements in other contexts such as, e.g., buildings.

The accelerometer per se can be commercially acquired and can be connected to the controller which covers operation of the system. A proximity sensor can also be used, as well as other sensing devices capable of detecting movement or motion.

A key aspect of this product function is the ability to determine when to initiate the wireless communication required to determine if the telephone is nearby and thereby when to inform the user via audio tones or other alerts.

In the car mounted version of this product, the unit is placed on a car door, e.g., in the pocket of the car door. The sensing technology resident in the unit measures momentary acceleration in three separate directions, developing an acceleration profile. This profile serves as a fingerprint that differentiates door opening or closing from car turns or potholes. Thus, the unit activates only upon that door opening or closing. This capability provides two key product functions:

1. The product remains in a very low power state until motion activates the unit. Only then will the controlling microprocessor perform the in-depth data analysis required to qualify the collected data as a door opening, and proceed to employ Bluetooth communication to establish cellphone presence or absence. This feature enables the unit to remain in a low-power state most of the time, thus providing longer battery life while employing over-the-counter readily-available battery technology.

2. The acceleration profile required to identify door opening or closing includes the unique pattern created by activation of the door latching mechanism. Algorithmic analysis performed by the unit's microprocessor serves to identify this pattern and thereby enable the product to ignore car turning and pothole events that do not include this door-opening pattern.

The ability of this technology to identify many different kinds of doors is greatly extended by the inclusion of the following modes:

1. The unit may have one or more latch/accelerations signatures stores in memory. It can then compare any door motion with the stored information to determine if the door motion constitutes an opening or closing.

2. The unit may employ a learning mode. The user initiates this learning mode by entry of a unique button depression or button depression sequence on the unit. Learning mode expires in a fixed period of time. During this time, the user has been instructed by the product manual to open and close the door repeatedly. The unit stores key aspects of the learning mode collected data, developing a fingerprint that is used in operation to identify closing and opening of the door. Learning mode enables the unit to work on many different kinds of doors, swinging doors, and dresser drawers.

### BRIEF DESCRIPTION OF THE DRAWINGS

The invention will be more fully described in the following detailed description in conjunction with the drawings where:

FIG. 1 shows a device in accordance with the invention disposed in the side pocket of a car door.

FIG. 2 shows a functional block diagram of the device and major components.

FIG. 3 shows a flow chart of operation of a preferred embodiment.

FIG. 4 is a schematic diagram of the acceleration axes employed.

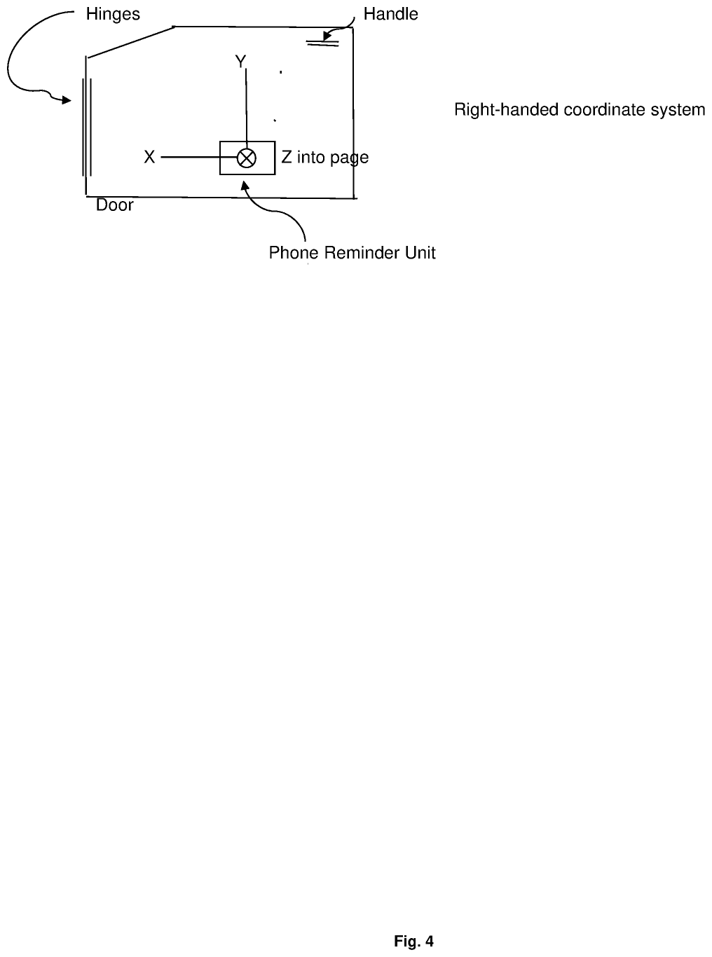

### DETAILED DESCRIPTION OF THE INVENTION

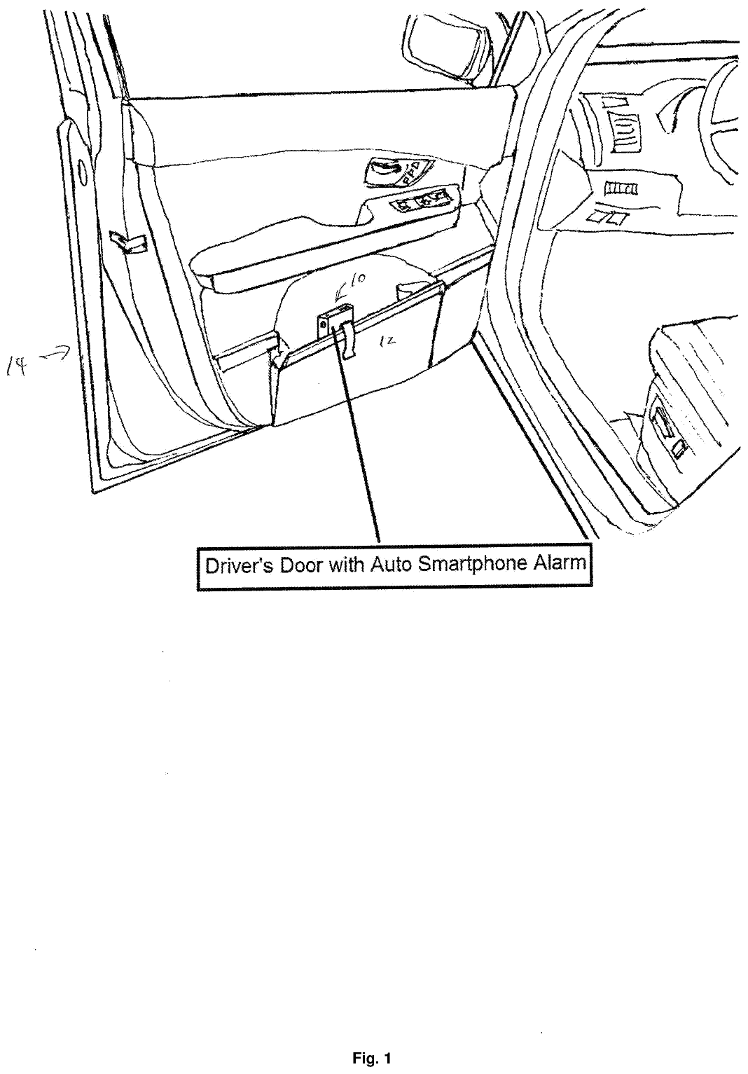

Referring to FIG. 1, one embodiment of the invention is illustrated in the form of a small unit 10 retained in the pocket 12 of a door 14 of a vehicle. The door 14 in the illustrated embodiment is the driver side door, although the invention may be embodied in association with any other door of the vehicle.

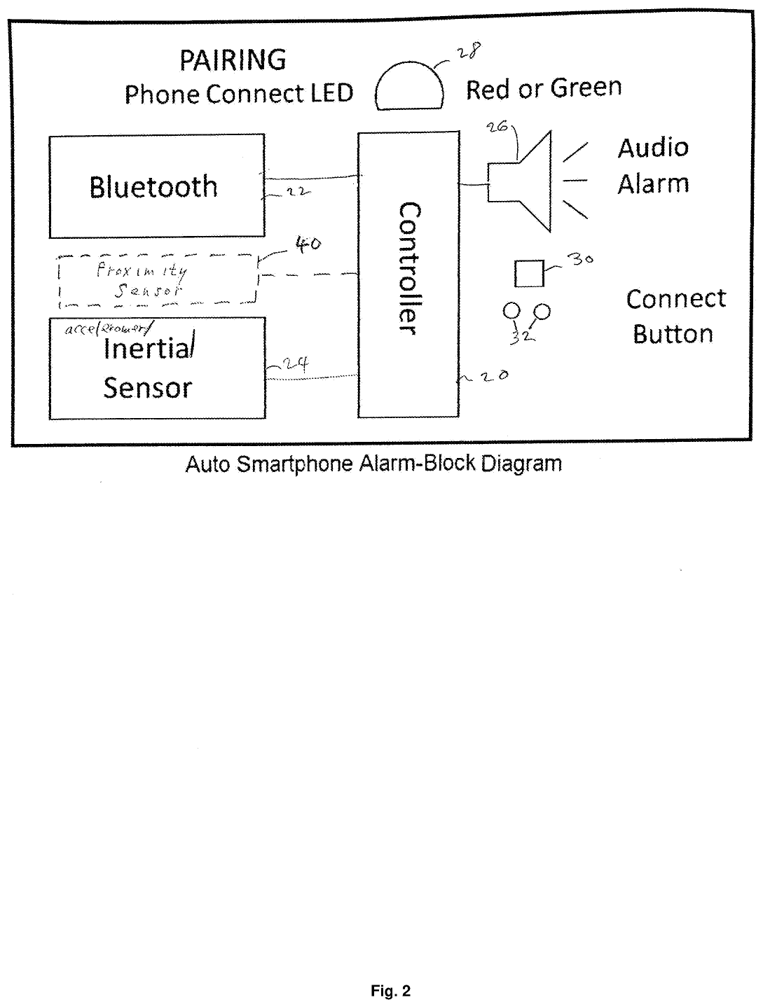

The unit 10 is illustrated in block diagram form in FIG. 2 and includes a controller 20, a Bluetooth or other wireless communication link 22 and an accelerometer or proximity sensor 24, an audio alarm 26 and visual indicators and control buttons. In the illustrated embodiment, an LED light 28 shows the paired status of the unit, for example, by lighting green to indicate that the unit is paired with the user's cell phone, or red to indicate that the unit is not paired. A power button 30 is provided to turn the unit on and off, and indicator lamps 32, typically LEDs, indicate power status. The controller 20 is typically an integrated circuit microcontroller having associated firmware or software to provide the intended functions. The construction and operation of microcontrollers are per se known to those skilled in the art. The unit is powered by one or more batteries disposed in the unit housing.

Each of the sensors provide a signal to the controller which is operative to produce the intended function. The accelerometer 24 or the proximity sensor 40 provides a signal to the controller 20 upon sensing vehicle door opening or closing, and the controller is triggered by that signal to search for the user's phone. Note that the sensor employed could include a microphone to perform audio analysis to determine door event occurrence. Upon detection of the phone, the controller causes an output indication to the user that the user's phone is present in the vehicle. Such output indication is by actuation by the controller of audible and/or visual indicators such as lamps 32 and audio alarm 26. The proximity sensor 40 provides a signal to the controller 20 upon sensing a person in the vehicle, and the controller employs that signal in determining the appropriate output indication as described herein.

In order to use the unit with a user's cell phone, there is an initial set up procedure by which the unit will be wirelessly paired with the user's phone. Typically, during a pairing process, the unit will be placed proximate to the user's phone, and the unit will automatically detect the phone presence or be instructed to seek the phone by pressing a pairing button on the unit. The pairing button may be the power button 30 which is long pressed for pairing, and short pressed for on/off. Or the pairing button may be a separate button on the unit. The unit employs Bluetooth or other wireless technology, which per se is known, to communicate between the unit and the phone. Once paired, the unit will recognize the user's phone for future use.

The paired unit is placed, for example, in the driver's side door of the user's vehicle. Typically, the unit can be clipped or otherwise placed in the door pocket as shown in FIG. 1. The unit contains an accelerometer or proximity sensor 24 operative to detect opening and closing of the vehicle door.

When a user opens the vehicle door to enter the car, the unit in the door senses door opening and is triggered to search for the user's cell phone. Upon detection of that phone, the unit provides an audible and/or visual alert to the user that the phone is present. The alert can be in the form of a distinctive tone or multiple tones to signify phone present status. Alternatively, the alert can be in the form of a verbal announcement that the phone is present. The alert may also be in visual form by flashing of a light which is visible to the user to signify a presence of the phone. Multiple audible and visual alerts may also be employed. Typically, the alert occurs within a short interval of time after the door is opened. A typical interval may be about two seconds.

If a user's phone is not detected when a user enters the vehicle, the absence of the phone is signified by a distinctive audible and/or visual indication to the user. This indication can be by one or more tones distinguishable from those employed for the phone present indication, or such an indication can be in the form of a suitable verbal announcement that the phone is not present. This indication serves as a reminder to the user that the phone is not present and may have been forgotten.

A similar operation is performed when a user is about to leave the vehicle. When a user opens the car door to leave the vehicle, the unit detects the door opening and phone presence and provides an indication to the user to serve as a reminder to take the phone when exiting the car. This indication is a distinctive tone or tones or verbal announcement and may also be in the form of a visual alarm, which may be employed together with an audible alarm or separately.

In another embodiment, the unit is able to detect, in addition to detection of door opening and closing, the presence of a person in a seat of the vehicle. This can be accomplished by use of a proximity sensor or detector 40 in the unit, which is operative to sense the presence of a person in the vehicle. When a user opens the car door and leaves the vehicle without the phone, the unit senses the presence of the phone in the car and the absence of the user in the car, and provides an indication to the user that the phone has been left in the car. Such an indication can be provided, for example, by beeping the car horn, flashing the car lights or other audible or visual indication provided by the vehicle or by a separate alarm device carried by the user, or noticeable by the user, or the device itself.

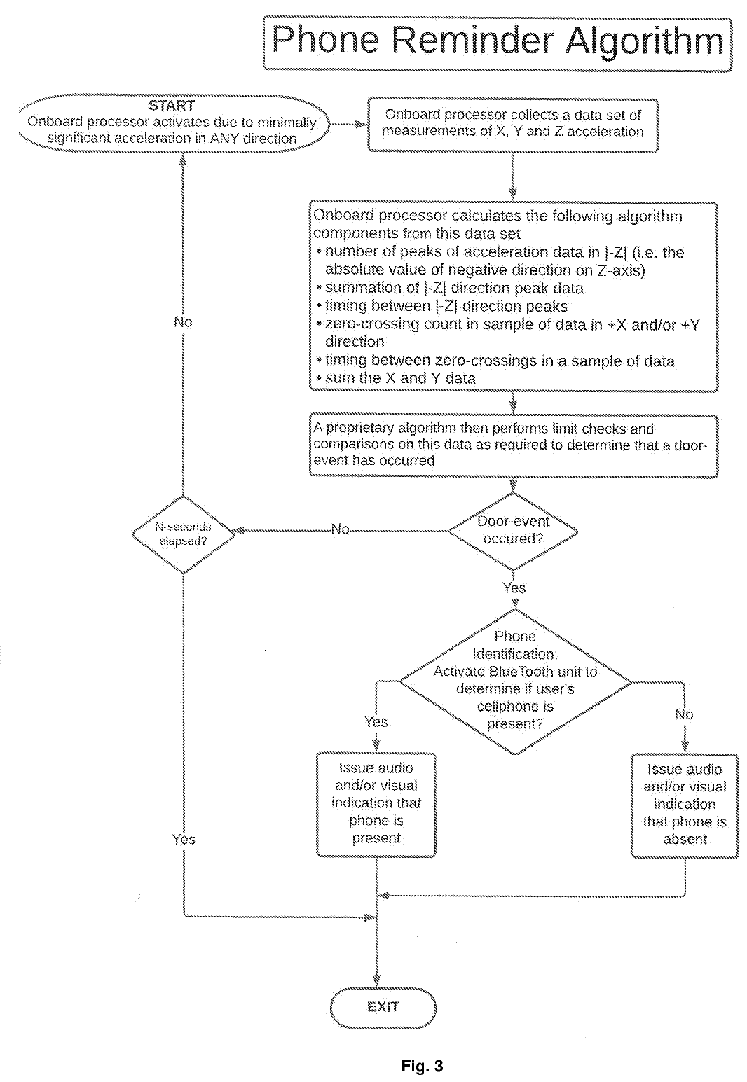

In another embodiment, shown in FIG. 3, a proximity sensor 40 is utilized, and no door sensing is employed. The presence of a user entering or exiting the vehicle is sensed by proximity detection of the user. In this embodiment, the detection of phone presence and the presence of a user in the vehicle signifies to the user that his or her phone is present. The detection of a phone in the vehicle and detection of no user in the vehicle, signifies that the phone has been left in the vehicle.

In a further embodiment, the invention may be implemented in an integral manner in association with the electronics and computer intelligence built into the vehicle. In this embodiment, the functionality of the unit 10 is built into the car electronics system or cooperative with such electronics system. The sensing of door opening and closing can be provided by a sensor built into the door or by making use of the door switch to provide an indication of the opening and closing of the door. The detection of a person in a vehicle seat can be detected by the seat sensors present in the vehicle. Pairing of the user's phone is often done by the user in coupling the phone to the hands-free phone system of the vehicle. The paired phone can be used for purposes of the present invention, in addition to the hands-free phone operation. Audible and visual alarms existing in the vehicle can be utilized, such as the vehicle horn, other audible alarm sounds and visual alerts.

The invention may be employed with any one or more doors of the vehicle, and the vehicle may be of any type including cars, trucks, specialty vehicles and the like. In another embodiment, the device may be plugged in or otherwise powered by a power source other than a battery.

The invention may be employed in venues other than a vehicle, such as a boat, house or office, having a moveable door. In this use, the device is placed on the door to sense door opening and closing. The door opening or closing triggers the device to search for the user's phone and, if the phone is detected, to provide an indication to the user that the phone is present. If the phone is not detected, a “no phone” indication is provided to the user by an audible and/or visual alert, as described above. In an alternative embodiment, only a “no phone” alert is provided in the absence of phone detection by the device. In this alternative embodiment if the phone is detected by the device, no alert is provided.

The device can be implemented to pair with multiple phones for use by respective persons, or multiple phones used by the same person. For example, different persons using a car can employ this multi-phone version of the invention to alert each person of phone presence and absence. The alerts may be the same for all phones linked to the device, or may be different for each user.

1. A phone reminder device comprising:
a unit placeable in a venue having a door, the unit including:
a sensor to detect the opening and/or closing of the venue door;
a wireless communications link to a user's cell phone;
at least one audio and/or visual indicator;
a controller coupled to the sensor, wireless communications link and at least one audio and/or visual indicator and providing unit operation;
the unit being operative when a user enters or exits the venue to sense door opening and/or closing and to trigger the unit to search for the user's phone and upon detection of that phone to provide a first indication to the user that the phone is present, and upon no detection of that phone to provide a second indication to the user that the phone is absent.

2. The phone reminder device of claim 1 wherein the first indication is audibly distinguishable from the second indication.

3. The phone reminder device of claim 1 wherein the first and second indications are verbal announcements.

4. The phone reminder device of claim 1 wherein the first indication is visually distinguishable from the second indication.

5. The phone reminder device of claim 1 wherein the first and second indications are both audible and visual.

6. The phone reminder device of claim 1 wherein the venue is a vehicle.

7. The phone reminder device of claim 6 wherein the first and second indications employ audible alarms of the vehicle.

8. The phone reminder device of claim 6 further including a proximity sensor to detect the presence of a person in the vehicle and to provide a signal indication thereof, the unit being operative when the user opens the car door and no person is detected in the vehicle to provide an indication that the phone remains in the vehicle.

9. The phone reminder device of claim 6 further including a seat detector operative to provide a signal indication of a person occupying the seat.

10. The phone reminder device of claim 6 wherein the unit is functionally integrated with the vehicle electronics system.

11. The phone reminder device of claim 1 wherein the unit is operative to provide only the second indication to the user that the phone is absent.

12. The phone reminder device of claim 1 wherein the unit is operative to detect and operate with multiple cell phones.

13. A method for providing a reminder to a user to remember the user's cell phone, the method comprising the steps of:
placing a user unit in a venue having a door for entry into and exit from the venue;
providing wireless communication between a user's cell phone and a user unit;
pairing the user's cell phone with the user unit;
detecting the opening and closing of the door; and
providing a first indication to the user that the user's phone is absent upon no detection of the user's phone and detection of door opening and/or closing.

14. The method of claim 13 further including:
providing a second indication to the user that the user's phone is present in the venue upon detection of the user's phone and detection of door opening and/or closing.

15. The method of claim 13 further including:
providing a sensor to determine the presence of a person in the venue;
providing an indication to a user that the user's phone is not present in the venue whenever the person-present status changes.

16. The method of claim 15 wherein the venue is a vehicle having a door.

17. The method of claim 16 including:
providing an indication to a user that the phone is present in the vehicle upon detection of the user's phone and detection of a person occupying a vehicle seat.

18. The method of claim 16 including:
providing an indication to a user that the phone has been left in the vehicle upon detection of the user's phone and detection of no person occupying a vehicle seat.

19. The system of claim 1 wherein the door sensor is operative to monitor the movement of one or more elements of a door lock mechanism and establish a signal profile unique to the lock mechanism.

20. The system of claim 19 wherein the door sensor is an accelerometer.

21. The system of claim 19 wherein the door sensor is a proximity sensor.

22. The system of claim 19 including a memory to store a representation of the signal profile.
